(19) United States
(12) Patent Application Publication
(10) Pub. No.: US 2013/0346119 A1
(43) Pub. Date: Dec. 26, 2013

(54) TECHNIQUES FOR BOOKING TRAVEL RESERVATIONS WHILE LEVERAGING TRAVEL WEBSITES

(71) Applicants: David LeCompte, Whitefish, MT (US); Christine Dohmen, Waverly, IA (US); Kristi Lamont, Denver, CO (US)

(72) Inventors: David LeCompte, Whitefish, MT (US); Christine Dohmen, Waverly, IA (US); Kristi Lamont, Denver, CO (US)

(73) Assignee: Short's Travel Management, Waterloo, IA (US)

(21) Appl. No.: 13/531,669

(22) Filed: Jun. 25, 2012

(51) Int. Cl. G06Q 10/02

(52) U.S. Cl. 705/5

(57) ABSTRACT

A computer-implemented method is provided for booking a travel reservation in accordance with an organizational travel policy while leveraging search capabilities of travel websites. The method includes: receiving a request for a reservation for a travel service at a travel management service from a person associated with an organization of persons; confirming availability of the requested reservation by interfacing with a reservation system of the travel service provider; evaluating the requested reservation in relation to a travel policy of the organization; and sending a message confirming availability of the reservation to the person

### FIELD

The present disclosure relates to an improved method for booking travel reservations in accordance with organizational travel policies while leveraging search capabilities of travel websites.

### BACKGROUND

Travel management companies help large organizations manage travel procurement and related expenditures. In doing so, many travel management companies offer corporate self-booking tools which enable employees to search for and make travel reservations, including airline, car rental, and hotel reservations. Reservations requests are in turn evaluated by the self-booking tools against corporate travel policies defined by the traveler's employer and the organization's supplier discounts are applied. The self-booking tools are typically developed and maintained by the travel management companies for use by their customers.

Concurrently, travel websites, such as Expedia and Kayak, continue to gain popularity amongst all travelers. To maintain growth, these travel websites are investing millions of dollars into user interface improvements and backend search capabilities. As travel websites continue to improve, corporate travelers are foregoing use of corporate self-booking tools in favor of these travel websites. Consequently, the benefits provided by corporate self-booking tools are not being realized by the many companies.

Accordingly, there is a need to improve upon the process of booking travel reservations for corporate travelers while leveraging the search capabilities of travel websites. This section provides background information related to the present disclosure which is not necessarily prior art.

### SUMMARY

A computer-implemented method is provided for booking a travel reservation in accordance with an organizational travel policy. The method includes: receiving an electronic message over a network from a person associated with an organization of persons, where the message includes a request for a reservation for a travel service from a travel service provider; confirming availability of the requested reservation by interfacing with a reservation system of the travel service provider; evaluating the requested reservation in relation to a travel policy of the organization, applying the organization's supplier discounts; and sending a message confirming availability of the reservation to the person.

In another aspect of this disclosure, the method for booking travel reservations is further defined as follows. The electronic message embodying the reservation request is parsed at a server computer. The person requesting the reservation is first identified from the parsed message such that a travel policy associated with the person can be retrieved. The requested itinerary is also determined from the parsed message. To confirm availability of the requested reservation, an available itinerary matching the requested itinerary is retrieved by interfacing with the reservation system of the travel service provider. The available itinerary is then evaluated in relation to a travel policy of the organization before a message confirming availability of the reservation is sent to the person.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a diagram depicting an exemplary travel management system;

FIGS. 2A and 2B illustrate two exemplary user interfaces from a travel website;

FIG. 3 is a diagram depicting an exemplary embodiment of the travel management service;

FIG. 4 is a flowchart depicting an exemplary embodiment for the incoming message handler;

FIG. 5 is a flowchart depicting an exemplary embodiment for the policy evaluator; and

FIGS. 6A-6C illustrate exemplary messages sent to a user of the travel management service.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

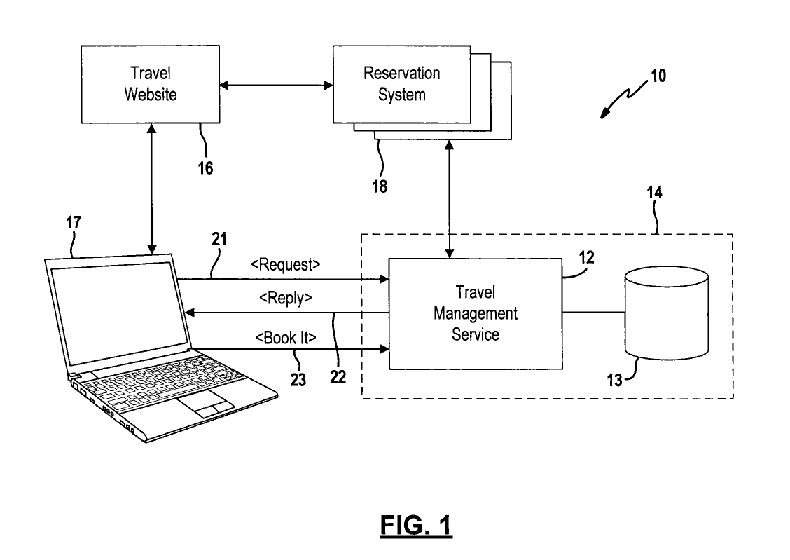

FIG. 1 depicts an exemplary travel management system 10 suitable for making travel reservations in accordance with a travel policy. The travel management system 10 includes a travel management service 12 and an associated data store 13 which are hosted preferably by a server computer 14. The travel management service 12 is a software-implemented tool that enables organizations to manage travel procurement and related expenditures (also referred to as a booking tool or travel management tool). In some embodiments, the travel management service 12 may be administered by the organization itself. In other embodiments, the organization may outsource the travel management service 12 to a travel management entity, such as American Express or Carlson Wagonlit.

Organizations may establish travel policies for procuring travel services. For example, employees may be permitted to travel in first class or business class for flights over six hours in duration but are restricted to coach class for flights having duration less than six hours. In another example, employees may be required to select the lowest cost option within a predefined period of time. It is readily understood that these travel policies are merely illustrative of the different policy types. Travel policies are in turn stored in data store 13 and made accessible to the travel management service 12. While reference is made throughout the application to airlines reservations, it is readily understood that the travel management service 12 described herein are applicable to other types of travel services including but not limited to hotel reservations, car rentals, tours, etc.

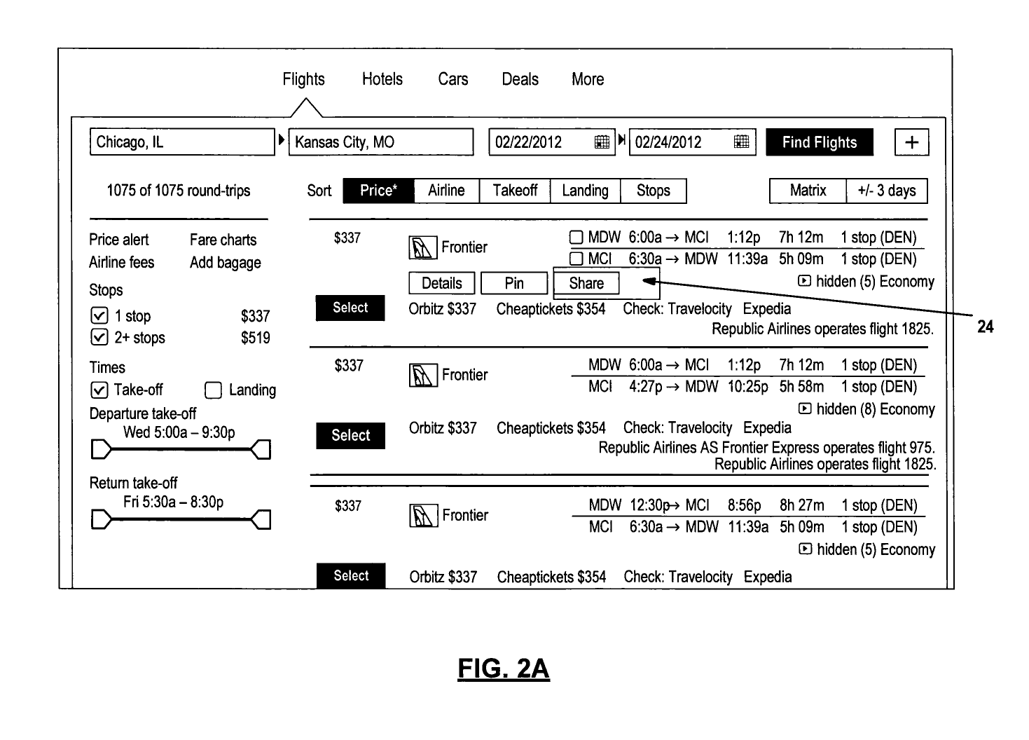

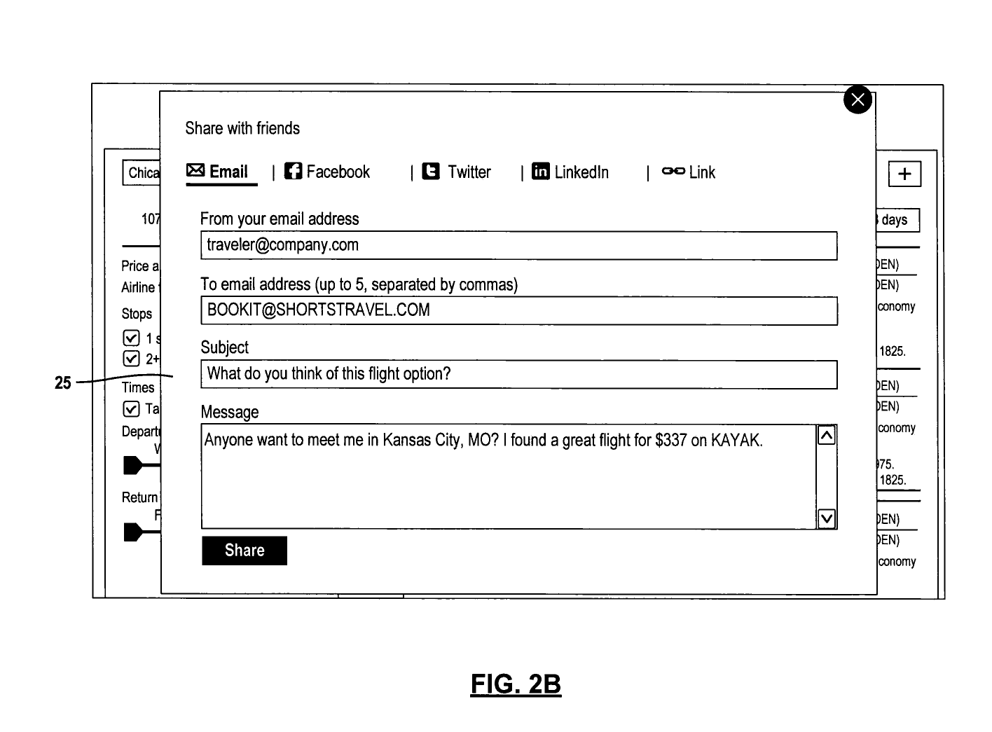

When procuring travel reservations, travelers will often search for available travel services utilizing well known travel websites 16, such as Expedia, Orbitz, Kayak, etc. Typically, a traveler will enter search criteria and initiate searches for available travel services at a given travel website 16. To fulfill search requests, the travel website 16 interfaces with one or more reservations systems 18 of travel service providers. In the case of airlines reservations, the travel websites 16 interface with the reservations systems 18 of the airlines such as Delta and United Airlines. Search results meeting a traveler's search criteria are then displayed to the traveler as shown in FIG. 2A. Travel websites 16 may be accessed by travelers using a mobile phone, a desktop computer or some other type of computing device designated at 17.

With a continued reference to FIG. 1, an improved method is provided for booking a travel reservation that leverages the search capabilities of travel websites while adhering to travel policies administered by a travel management service. Most travel websites enable the traveler to share a particular itinerary for the travel service being searched, for example, as indicated at 24 of FIG. 2A. More specifically, the traveler is able to send an email message to a designated recipient at 25 as shown in FIG. 2B. In the context of this disclosure, the traveler directs an email message at 21 to an email address (e.g., bookit@shortstravel.com) associated with the travel management service 12. The email message is viewed as a request for a travel reservation and processed by the travel management service 12.

Upon receipt of the email, the travel management service 12 operates generally to confirm availability of the requested reservation with the travel service provider and evaluates the requested reservation in relation to the travel policies of the organization in which the traveler belongs, and applies the organization's supplier discounts. Each of these steps will be described in more detail below. The travel management service 12 then sends a confirmatory message at 22 to the traveler.

Content of the confirmatory message depends upon the outcome of the assessments made by the travel management service 12. For instance, the confirmatory message may indicate that the requested reservation is available and thereby prompt the traveler to book the reservation. In response to the confirmatory message, the traveler may opt to send a message back at 23 to the travel management service 12 requesting procurement of the reservation. In other instances, the requested reservation may no longer be available for booking or be non-compliant with the applicable travel policies. Content of the confirmatory message in these instances will vary accordingly.

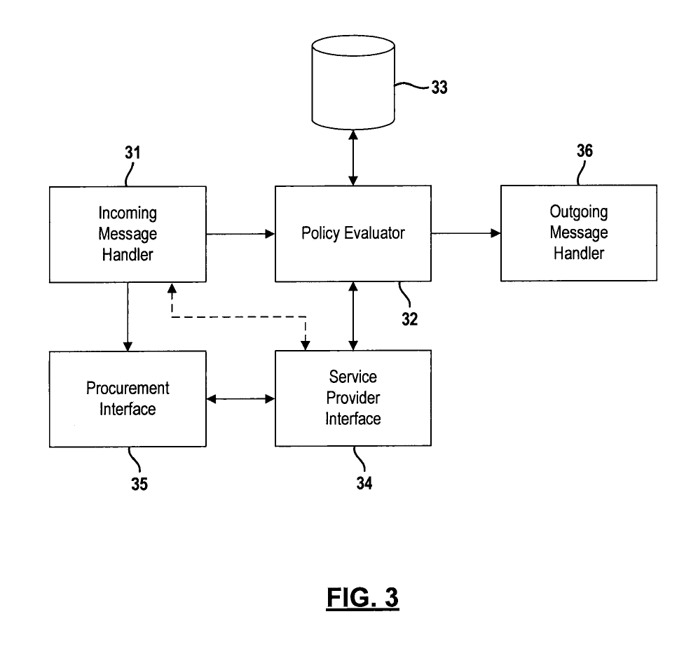

FIG. 3 further depicts an exemplary embodiment of the travel management service 12 in accordance with this disclosure. The travel management service is comprised generally of an incoming message handler 31, a policy evaluator 32, a service provider interface 34, a procurement interface 35 and an outgoing message handler 36. Functions supported by each of these components are further described below.

Incoming message handler 31 in configured to pre-process email messages directed to the travel management service 12. To do so, the incoming message handler 31 will periodically poll an email server for incoming messages associated with a designated email address (e.g., bookit@shortstravel.com). In some embodiments, the message handler 31 may support a single email address. In other embodiments, the message handler 31 may support more than one email address, for example, a different email address or mailbox for each account (i.e., organization). In these embodiments, the message handler 31 loops through the email messages in each of mailboxes.

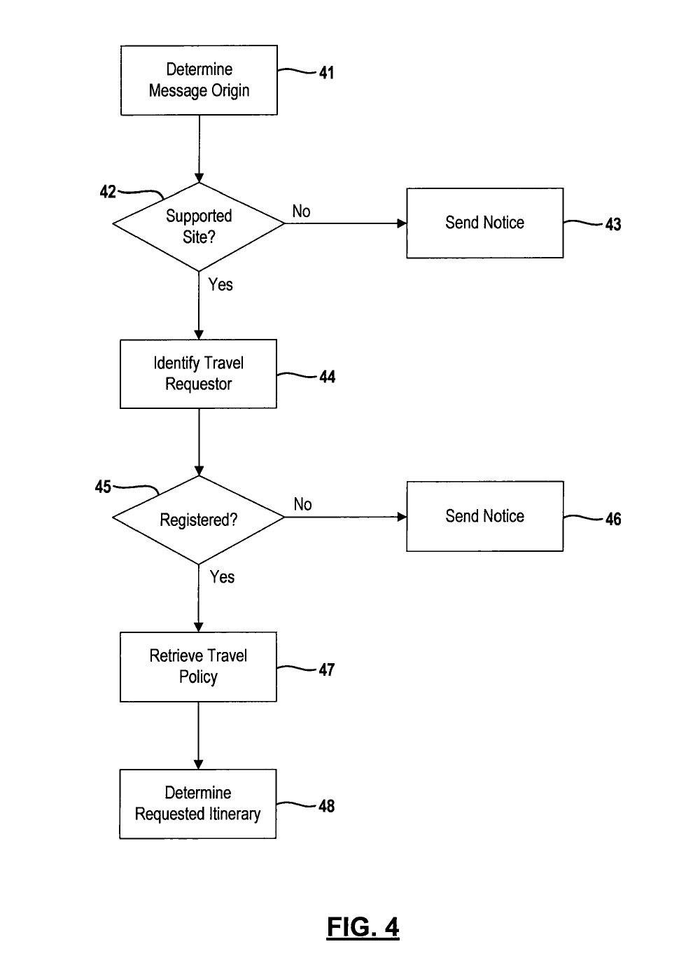

FIG. 4 further depicts an exemplary embodiment for the incoming message handler 31. For each incoming message, the incoming message handler 31 makes a determination at 41 as to which travel website the message originated from. This determination may be done in different manners including from indicia contained in the incoming message. A subsequent determination is made at 42 as to whether the identified travel website is supported by the travel management service 12. When the email message originated from a supported travel website, the email message may be further parsed; otherwise, a message is sent at 43 to the traveler making the reservation request, where the message notifies the traveler that the travel website is not supported. The reply message may also suggest using a supported travel website or accessing a portal associated with the travel management service 12.

Next, the incoming message handler 31 confirms the identity of the traveler making the reservation request at 44. In the exemplary embodiment, the traveler may be identified from the email address in the sender field. The traveler's identity is then checked against a database of registered users. For registered users, an applicable travel policy may be retrieved at 47. Since travelers are associated with a particular organization (i.e., employer), the message handler 31 first determines the organization to which the traveler belongs and then retrieves the travel policy associated with that organization. Alternatively, the retrieval of the travel policy may be handled by the policy evaluator 32. In the event the traveler is not a registered user or is not associated with a registered organization, further processing is terminated and an appropriate message is sent at 46 to the traveler.

The incoming message handler 31 also parses incoming messages at 48 to determine the requested itinerary or other identifying information for the requested travel service. In the case of an airline reservation, the requested itinerary may include but is not limited to an airline, a flight number, a date, an arrival time, a departure time, and a quote price. It is readily understood that identifying information may vary for other types of travel services. The requested itinerary, along with other identifying information parsed from or otherwise derived from the incoming message, is then passed along to the policy evaluator 32 for subsequent processing.

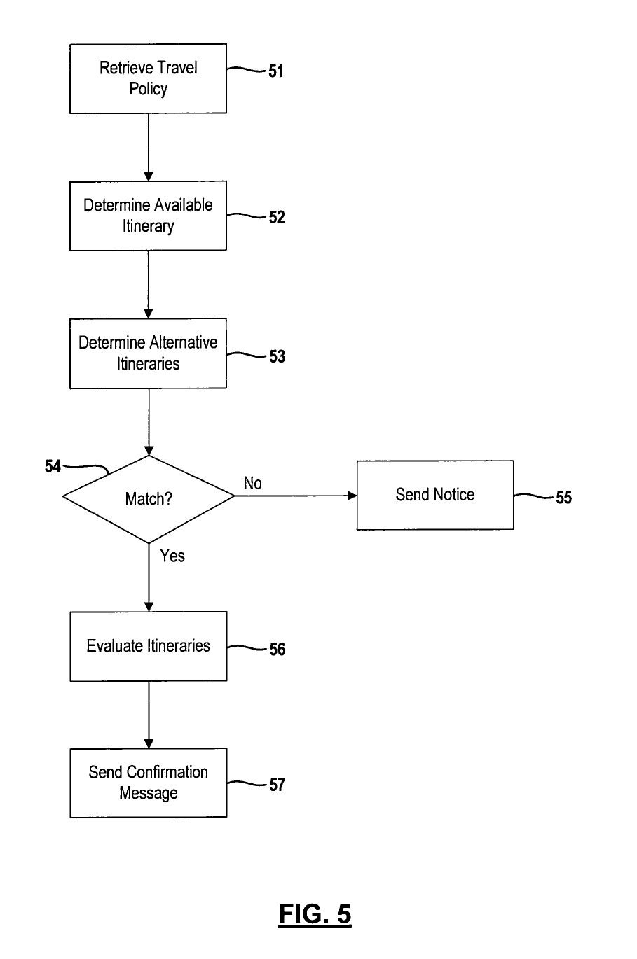

FIG. 5 depicts an exemplary embodiment for the policy evaluator 32. The policy evaluator 32 is generally responsible for confirming the availability of the requested reservation and evaluating the requested reservation in relation to an applicable travel policy. In the exemplary embodiment, the policy evaluator 32 receives the requested itinerary along with the other information derived from the incoming message. In some embodiments, the travel policy associated with the traveler may be retrieved by the incoming message handler 31 and passed along to the policy evaluator 32. In other embodiments, the policy evaluator 32 may retrieve the applicable travel policy directly from the data store 33.

Next, the policy evaluator 32 determines at 52 an available itinerary for the requested travel service by interfacing with a reservation system associated with the travel service provider or through an industry wide computer reservation system like Travelport's Apollo global distribution system (commonly referred to as a Global Distribution System). For example, the availability of a requested airline reservation for a flight offered by Delta Airlines can be checked by querying Delta's reservation system. The query is made using the itinerary information passed from the incoming message. An available itinerary is one that matches criteria specified for the requested itinerary. In some instances, it is envisioned that not all of the search criteria may be available from the incoming message (e.g., departure and arrival times) depending on the interface supported by the travel website 16. In other instances, one or more search criteria (e.g., a quoted price) may have changed from the time the query was made using the travel website 16. In either of these instances, the policy evaluator 32 may apply matching criteria to determine whether an available itinerary matches the requested itinerary, where the criteria specifies which data fields of the itinerary must match or may be optional as well as the type of correlation needed for a match. This step ensures that the requested reservation remains available for booking and verifies the accuracy of the requested itinerary. To the extent that an available itinerary varies from the requested itinerary, such variations will be indicated to the traveler.

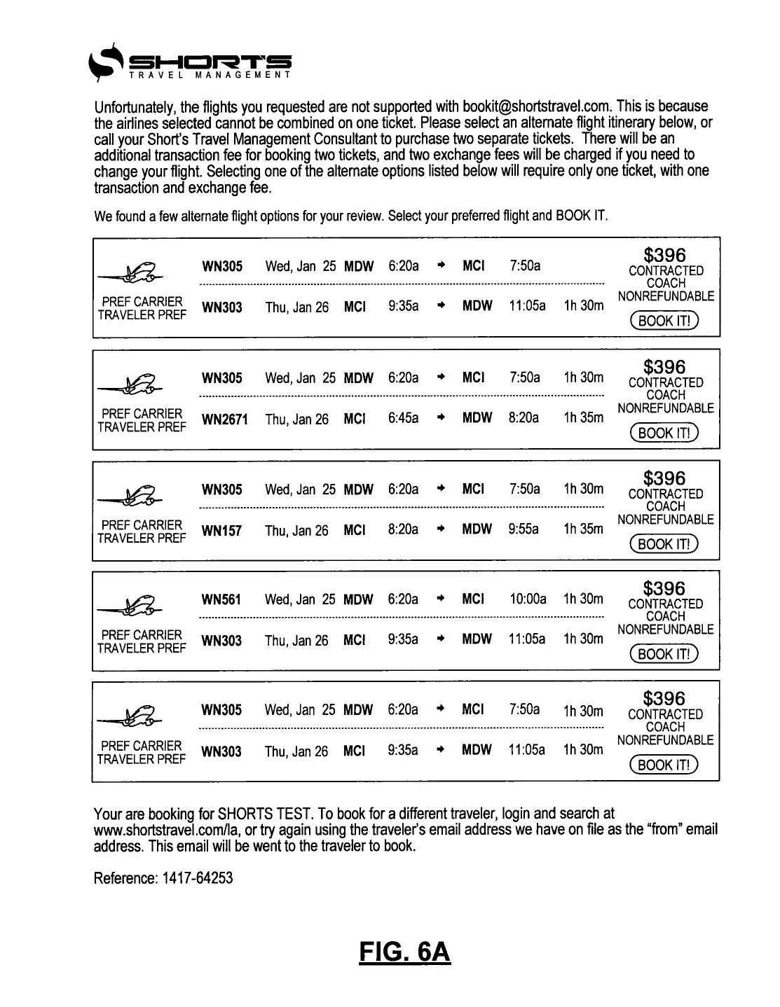

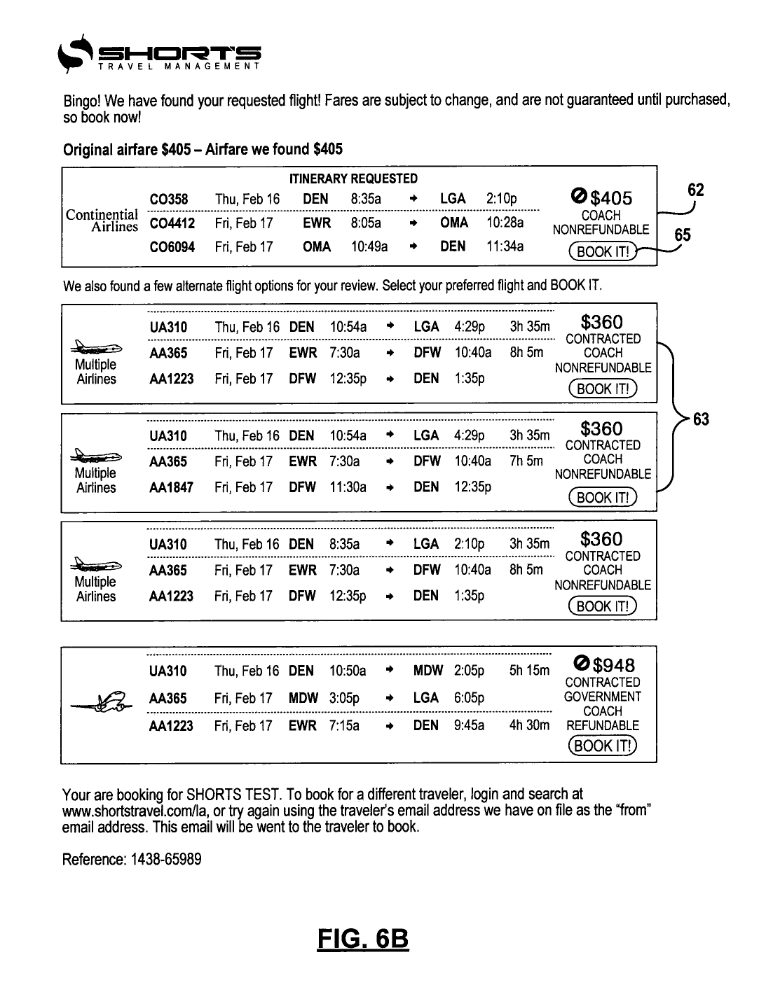

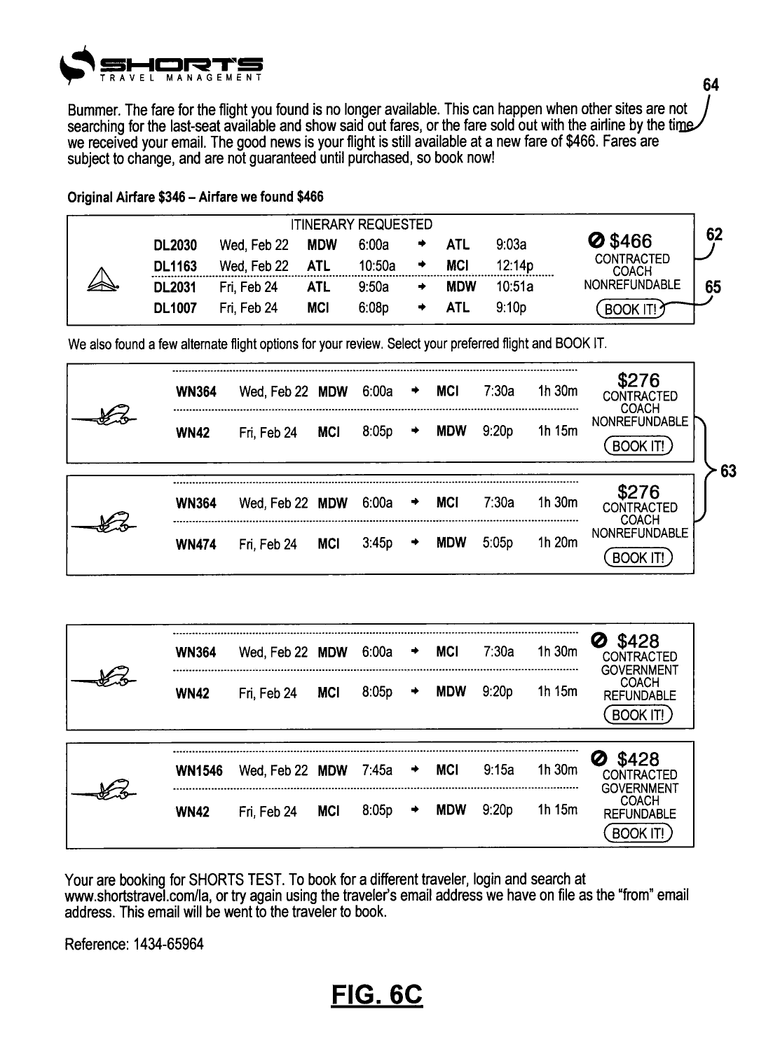

When no available itinerary matches the requested itinerary, the policy evaluator 32 notifies the requesting traveler as indicated at 55. In the exemplary embodiment, the traveler may be notified by an email message indicating that the requested itinerary was not found, for example, as shown in FIG. 6A. In this case, the email message sent to the traveler may include alternative itineraries as further described below.

That is, the policy evaluator 32 will also determine at 53 if there are other itineraries which are similar or related to the requested itinerary. For example, a similar itinerary may be one that falls within a predefined window of time (e.g., an airline reservation for the same city pair having an arrival time within 3 hours of the requested itinerary) and/or a predefined range of the quoted price for the requested reservation, and/or shorter travel times. Other types of criteria for determining similarity are readily apparent and may be applied by the policy evaluator 32. Moreover, it is envisioned that the alternative itineraries may be from the same or different service provider.

Given a listing of available itineraries, the policy evaluator 32 will then evaluate at 56 each available itinerary in relation the applicable travel policy. Travel policies specify rules for travel reservations made by travelers of a given organization, such as an employer or a professional association. For example, a travel policy may specify that the cost of a travel service may not exceed a maximum value. Software tools that enable organizations to define travel policies and evaluate travel requests in relation to such travel policies are commercially available from the applicant as well as other travel management companies.

Once the evaluation is complete, the policy evaluator 32 interfaces with the outgoing message handler 36 to send at 57 a confirmatory message to the traveler. In an exemplary embodiment, the confirmatory message is in the form of an email message that is sent over a network to the traveler. The confirmatory message may be sent using other types of messaging schemes including but not limited to instant messaging, text messaging, and voice messaging.

With reference to FIG. 6B, the confirmatory message provides an indication of the availability of the requested itinerary. The confirmatory message preferably includes the available itinerary for the requested travel service including the quoted price as indicated at 62. When the available itinerary varies from the requested itinerary, the confirmatory message may provide an indicator 64 of differences between the available itinerary and the requested itinerary as shown in FIG. 6C. Additionally, the confirmatory message may include one or more alternative itineraries 63 for consideration by the traveler. Alternative itineraries that violate the applicable travel policy are preferably excluded by the policy evaluator 32 from the confirmatory message or are included and denoted as outside of the organization's policy.

To facilitate booking of an available itinerary, the confirmatory message further includes at least one push button 65 or another type of user interface element for initiating booking of a reservation. In an exemplary embodiment, each available itinerary is presented in a dialog box having a push button therein for the initiating booking of the associated itinerary. Each push button provides a hyperlink back to the travel management service 12.

Upon selection of an available itinerary, the traveler is brought to a checkout page rendered by the procurement interface 35. In an exemplary embodiment, the traveler is automatically signed in to the travel management service 12 using the email address from the confirmatory message and thus brought directly to the checkout page. In other embodiments, the traveler may be required to sign on before being brought to the checkout page. The checkout page may display a traveler's profile information along with the selected itinerary. In the event the confirmatory message is sent or otherwise accessible to someone other than the traveler, credit card information and other sensitive data associated with the traveler's profile may be grayed out on or excluded from the checkout page. The checkout page may also display suggestion for complementing the selected itinerary, such as adding a car or hotel reservation. In the example of a flight reservation, suggested car and/or hotel reservation may be generated based on the flight dates and destination. The traveler may elect to add additional reservations to their itinerary. Additional reservations can be evaluated by the policy evaluator 32 in relation to an applicable travel policy in the manner described above.

Upon reviewing the selected itinerary, the travel can elect to purchase the selected travel services. The procurement interface 35 interacts with the reservation system of the travel service provider or with an industry wide computer reservation system to book the reservation. Under certain circumstances (e.g., preferred travelers status), the checkout page may be bypassed. Rather, the traveler is automatically signed in to the travel management service and the procurement interface 35 interacts with the reservation system of the travel service provider or with an industry wide computer reservation system to book the reservation. In either case, the traveler is presented with a confirmatory webpage once the reservation is booked. The procurement interface 35 may also interact with the outgoing message handler 36 to send the requesting traveler a confirmation (email) message, including a confirmation identifier provided by the travel service provider.

In an alternative approach, a procurement message is generated and sent from the computing device of the traveler over the data network and back to the travel management service 12 when one of the push buttons presented on the confirmatory message is actuated by the message recipient. The procurement message indicates generally the travelers desire to book a reservation with the travel service provider. In an exemplary embodiment, the procurement message may include a reference identifier that uniquely identifies the selected itinerary to the travel management service 12. The procurement message is again directed to an email address (e.g., bookit@shortstravel.com) associated with the travel management.

Upon receipt of the procurement message, the travel service management service 12 operates to book the reservation with the travel service provider. More specifically, the procurement message is received by the incoming message handler 31. The incoming message handler 31 recognizes the message type and forwards the procurement message on to the procurement interface 35. The procurement interface 35 interacts with the reservation system of the travel service provider or with an industry wide computer reservation system to book the reservation. The procurement interface 35 may also interact with the outgoing message handler 36 to send the requesting traveler a confirmation message, including a confirmation identifier provided by the travel service provider.

In another variant of this disclosure, registered users may be encouraged or required to download a supporting software application to their computing device. Once installed, the supporting application can further complement the core functionality of the travel management service. For example, the supporting application may monitor the travel websites accessed by the user. When a user is viewing a website of a service provide that is not preferred or compliant with the applicable travel policy, the supporting application may provide a pop-up notification making the user aware of the travel policy (e.g., “Delta Airlines is not a preferred carrier under your company's travel policy” or “Please consider booking to Delta in lieu of American Airlines”). In another example, once the user has selected a reservation on a travel website, another pop-up notification may advise or remind the user to book with the travel management service. In one embodiment, the user is prompted for identifying information (e.g., email address) and then redirected by the supporting application to the travel management service. Information pertaining to user and the selected reservation may be passed along to the travel management service for processing in the manner set forth above and without having to send an email.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for booking a travel reservation in accordance with an organizational travel policy, comprising:
receiving, at a server computer, an electronic message over a network from a given person associated with an organization of persons, the message includes a request for a reservation for a travel service from a travel service provider;
confirming, by the server computer, availability of the requested reservation by interfacing with a reservation system of the travel service provider or an industry wide computer reservation system;
evaluating, by the server computer, the requested reservation in relation to a travel policy of the organization, where the travel policy specifies rules for travel reservations made by persons of the organization; and
sending, by the server computer, a confirmation message over the network to the given person, the confirmation message providing an indication of the availability of the reservation.

2. The computer-implemented method of claim 1 further comprises
receiving, at the server computer, a procurement message over the network from the given person, the procurement message being sent in response to the confirmation message; and
procuring, by the server computer, a reservation for the given person by interfacing with the reservation system of the travel service provider.

3. The computer-implemented method of claim 1 further comprises
parsing, by the server computer, the electronic message received from the given person;
determining, by the server computer, a requested itinerary for the travel service from the parsed electronic message; and
querying, by the server computer, the reservation system of the travel service provider using the requested itinerary.

4. The computer-implemented method of claim 3 further comprises
retrieving, by the server computer, an available itinerary for the travel service from the reservation system, where the available itinerary matches the requested itinerary for the travel service;
incorporating, by the server computer, the available itinerary into the confirmation message.

5. The computer-implemented method of claim 3 further comprises providing an indicator of differences between the available itinerary and the requested itinerary in the confirmation message.

6. The computer-implemented method of claim 3 further comprises
retrieving, by the server computer, other itineraries for the travel service from the reservation system, where the other itineraries are similar to the requested itinerary; and
incorporating, by the server computer, the other itineraries into the confirmation message sent to the given person.

7. The computer-implemented method of claim 6 further comprises evaluating the other itineraries in relation to the travel policy before incorporating the other itineraries into the confirmation message.

8. The computer-implemented method of claim 3 further comprises
identifying the given person from the parsed electronic message;
retrieving the travel policy associated with the given person;
evaluating the available reservation in relation to the travel policy of the organization; and
providing an indicia of non-compliance in the confirmation message when the available reservation does not comply with the travel policy.

9. The computer-implemented method of claim 1 further comprises:
parsing, by the server computer, the electronic message received from the given person;
determining, by the server computer, a travel website from which the electronic message was sent by the given person; and
sending, by the server computer, a reply message over the network to the given person when the travel website is not supported by the server computer, the reply message indicating another travel website supported by the server computer.

10. A computer-implemented method for booking a travel reservation for a given person associated with an organization, comprising:
receiving, at a server computer, an electronic message over a network from the given person, the message includes indicia of a requested itinerary for a travel service from a travel service provider;
parsing, by the server computer, the electronic message;
identifying the given person from the parsed electronic message;
retrieving a travel policy associated with the given person, where the travel policy specifies rules for travel reservations made by persons of the organization;
determining, by the server computer, a requested itinerary for the travel service from the parsed electronic message;
retrieving, by the server computer, an available itinerary for the travel service by interfacing with a reservation system associated with the travel service provider, where the available itinerary matches the requested itinerary for the travel service;
evaluating, by the server computer, the available itinerary in relation to a travel policy of the organization; and
sending, by the server computer, a confirmation message over the network to the given person, the confirmation message providing an indication of the availability of the request itinerary.

11. The computer-implemented method of claim 10 further comprises incorporating the available itinerary into the confirmation message.

12. The computer-implemented method of claim 10 further comprises
retrieving, by the server computer, other itineraries for the travel service from the reservation system, where the other itineraries are similar to the requested itinerary; and
incorporating, by the server computer, the other itineraries into the confirmation message sent to the given person.

13. The computer-implemented method of claim 12 further comprises evaluating the other itineraries in relation to the travel policy before incorporating the other itineraries into the confirmation message.

14. The computer-implemented method of claim 10 further comprises
receiving, at the server computer, a procurement message over the network from the given person, the procurement message being sent in response to the confirmation message; and
procuring, by the server computer, a reservation for the available itinerary for the given person by interfacing with the reservation system of the travel service provider.

15. A computer-implemented travel management service for booking a travel reservation in accordance with an organizational travel policy, comprising:
an incoming message handler configured to receive an electronic message from a given person, the incoming message handler operates to identify the given person and a requested itinerary for a travel service from the electronic message, wherein the message includes indicia of the requested itinerary for the travel service;
a policy evaluator configured to receive the requested itinerary from the incoming message handler and operates to retrieve an available itinerary for the travel service from the travel service provider, where the available itinerary matches the requested itinerary for the travel service;
the policy evaluator further configured to retrieve a travel policy associated with the given person and operates to evaluate the available itinerary in relation to the retrieved travel policy, where the travel policy specifies rules for travel reservations made by persons of the organization; and
a outgoing message handler in data communication with the policy evaluator and operable to send a confirmation message over a data network to the given person, the confirmation message providing an indication of the availability of the request itinerary is sent over a data network to the given person.

16. The travel management service of claim 15 wherein the policy evaluator interfaces with a reservation system associated with the travel service provider to retrieve the available itinerary.

17. The travel management service of claim 15 further comprises a procurement interface configured to render a web page for booking a reservation and operable to book a reservation with the travel service provider, the web page being rendered in response to a hyperlink encapsulated in the confirmation message.

18. The travel management service of claim 15 further comprises a procurement interface configured to receive a procurement message from the given person and operable to book a reservation with the travel service provider using an indicia of an itinerary selected by the given person, where the indicia of the selected itinerary is encapsulated in the confirmation message.
